(19) United States
(12) Patent Application Publication
(10) Pub. No.: US 2024/0330713 A1
(43) Pub. Date: Oct. 3, 2024

(54) SYSTEMS, APPARATUSES, METHODS, AND COMPUTER PROGRAM PRODUCTS FOR AUTOMATICALLY MAINTAINING SEEDED SEMANTIC OBJECT MODEL

(71) Applicant: Honeywell International Inc., Charlotte, NC (US)

(72) Inventors: Veeranagegowda Shivalingappa, Hiriyuru (IN); Sumanth Pachipulusu Lingesh, Bengaluru (IN)

(21) Appl. No.: 18/193,133

(22) Filed: Mar. 30, 2023

(51) Int. Cl. G06N 5/022; G06N 5/02

(52) U.S. Cl. CPC G06N 5/022; G06N 5/027

(57) ABSTRACT

Embodiments of the disclosure provide for maintaining a seeded semantic object model based on independent semantic object models. Such embodiments enable automatically standardizing a seeded semantic object model across one or more domains. Some embodiments identify a plurality of independent semantic object models having a plurality of object types, process the plurality of object types to determine at least one similar object type, determine that the at least one similar object type satisfies model updating criteria, and in response to determining that the at least one similar object type satisfies the model updating criteria, update the seeded semantic object model based at least in part on the at least one similar object type.

### TECHNICAL FIELD

Embodiments of the present disclosure are generally directed to maintaining a seeded semantic object model, and specifically to automatically maintaining a seeded semantic object model utilizing data learning based on use cases.

### BACKGROUND

Extensible object models can provide flexible, robust, and self-service modeling capability that allows end users to independently manage object models. Applicant has discovered various technical problems associated with maintaining semantic object models. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for maintaining a seeded semantic object model based on independent semantic object models. Other implementations for maintaining a seeded semantic object model based on independent semantic object models a will be, or will become, apparent to one with skill in the art upon examination of the following figures and detailed description. It is intended that all such additional implementations be included within this description, be within the scope of the disclosure, and be protected by the following claims.

In accordance with one aspect of the present disclosure, a computer-implemented method for maintaining a seeded semantic object model is provided. The computer-implemented method is executable utilizing any of a myriad of computing device(s) and/or combinations of hardware, software, and/or firmware. In some example embodiments, an example computer-implemented method includes identifying a plurality of independent semantic object models having a plurality of object types, each object type defined by one or more attributes, The example computer-implemented method further includes processing the plurality of object types to determine at least one similar object type based at least in part on the one or more attributes for each of the plurality of object types, the at least one similar object type shared between at least a subset of the plurality of independent semantic object models. The example computer-implemented method further includes determining that the at least one similar object type shared between at least the subset of the plurality of independent semantic object models satisfies model updating criteria, and in response to determining that the at least one similar object type shared between at least the subset of the plurality of independent semantic object models satisfies the model updating criteria, updating the seeded semantic object model based at least in part on the at least one similar object type shared between at least the subset of the plurality of independent semantic object models.

In some example embodiments, each of the plurality of independent semantic object models is independently customizable by at least one user.

In some example embodiments, the one or more attributes for each object type of the plurality of object types comprises a set of object properties for the object type.

In some example embodiments, the at least one similar object type is determined using a machine learning model.

In some example embodiments, the at least one similar object type is determined using a rules-based engine.

In some example embodiments, the model updating criteria comprise a certain percentage of the plurality of independent semantic object models having the at least one similar object type.

In some example embodiments, determining whether the at least one similar object type satisfies the model updating criteria is determined using a machine learning model.

In some example embodiments, determining whether the at least one similar object type satisfies the model updating criteria is determined using a rules-based engine.

In some example embodiments, updating the seeded semantic object model includes generating, in the seeded semantic object model, an additional object type corresponding to the at least one similar object type.

In some example embodiments, updating the seeded semantic object model includes replacing an existing object type in the seeded semantic object model with an object type corresponding to the at least one similar object type.

In some example embodiments, updating the seeded semantic object model includes updating, in the seeded semantic object model, at least one object attribute of an existing object type corresponding to the at least one similar object type.

In some example embodiments, the example computer-implemented method further includes deploying the updated seeded semantic object model to at least one new independent semantic object model.

In some example embodiments, determining whether to update the seeded semantic object model is performed at a defined time interval.

In some example embodiments, the example computer-implemented method further includes evaluating one or more attributes of an object type associated with an instance of an independent semantic object model of the plurality of independent semantic object models for presence of an instantiation condition indicative of a potential issue with respect to the object type, generating a notification in response to a detected instantiation condition, the notification comprising one or more of an alert notification, a warning notification, a recommendation notification, or a corrective action notification, and/or the like. The example computer-implemented method further includes transmitting the notification to a client device.

In accordance with another aspect of the present disclosure, an apparatus for maintaining a seeded semantic object model is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for maintaining a seeded semantic object model is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with at least some example embodiments of the present disclosure;

FIG. 3 illustrates a block diagram of an example apparatus embodying a client system in accordance with at least one embodiment of the present disclosure;

FIG. 3 illustrates a visualization of an example data environment for initiating instances of independent semantic object models.

FIG. 4 illustrates a visualization of an example data environment for providing seeded semantic object model template in accordance with at least one embodiment of the present disclosure;

FIG. 5 illustrates a visualization of an example data environment for initiating independent semantic object models instance(s) in accordance with at least one embodiment of the present disclosure;

FIG. 6 illustrates a visualization of an example data environment for updating seeded semantic object models in accordance with at least one embodiment of the present disclosure;

FIG. 7 illustrates a flowchart depicting operations of an example process for updating a seeded semantic object model in accordance with at least some example embodiments of the present disclosure;

FIG. 8 illustrates a flowchart depicting operations of an example process for determining similar object type(s) in accordance with at least some example embodiments of the present disclosure;

FIG. 9 illustrates a flowchart depicting operations of an example process for evaluating an independent semantic object model in accordance with at least some example embodiments of the present disclosure; and

FIG. 10 illustrates an operational example of a notification user interface in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview and Technical Improvements

In various contexts, a static or otherwise non-extensible object model may not be sufficient to represent the data important to a particular user. For example, a system and/or a user may require particular custom object models to represent assets or structures processed within a computing environment, where the custom object models are not described by standard object models. In an attempt to resolve these issues, systems that utilize an extendable object model (also referred to as extensible object model) that allows for customizable object models which fits a desired use may be provided. This can be beneficial for users with particular needs not accounted for in a standard object model.

An extendable object model, however, still suffers from other unique technical difficulties. Even where an extensible object model is utilized and an end user may readily create custom object model(s) for representation within the extendable object model, creating such custom object model(s) for representation within the extensible object model often requires additional engineering, manual upgrading of particular systems, and/or the like. Often times, programming or other personnel with technical expertise have to invest significant amount of resources to create custom object model(s) for storing to the extensible object model. Moreover, when a user creates custom object model(s) in an extensible object model, incorrect data may be introduced into the system due to, for example, lack of domain knowledge, human error, and/or the like. This in turn can lead to erroneous operation of the object model and/or rework which requires additional resources (e.g., computing resources, personnel resources, etc.) to correct the extensible object model for subsequent use.

Embodiments of the present disclosure are directed to maintaining a seeded semantic object model associated with an extensible object model. In particular, embodiments of the present disclosure are directed to automatically maintaining a seeded semantic model based on independent semantic object models that each allow a user to create custom object models and extend the seeded semantic object model in circumstances where certain data-driven triggers are met based on such individual object models. In some embodiments, object type(s) associated with a plurality of independent semantic object models are processed based on the attributes of the object type(s) to determine similar object type(s), and updating the seeded semantic object model occurs based at least in part on similar object type(s) deemed as qualifying similar object types for updating the seeded semantic object model. In this regard, embodiments of the present disclosure allow for automatically updating a seeded semantic object model to standardize across one or more domains based on individual use cases (e.g., distinct instances of independent semantic object models). In some embodiments, the updated seeded semantic object model may then be stored and subsequently deployed to a new independent semantic object model for new user(s), and/or in some circumstances utilized to update existing independent object model(s). In this regard, embodiments of the present disclosure ensure that a seeded semantic object model made available to new users consistently remains up to date without requiring configuring by the new user. Additionally or alternatively, such embodiments eliminate or at least reduce the need for additional manual engineering and/or other resources that would otherwise be needed to create custom object model(s) not originally provided. Furthermore, this eliminates the need for additional resources associated with manually standardizing a seeded semantic object model, as well as eliminates any potential human errors that may be introduced via such manual action.

Moreover, in some embodiments, custom object model(s) created by a user are evaluated for errors and/or potential issues in the object model(s). In some embodiments, in response to detecting an error and/or potential issue, one or more of an alert notification, a warning notification, or a recommendation notification is generated and transmitted to a client device associated with a user. Such embodiments eliminate or at least reduces the introduction of incorrect data into the system and eliminates or at least reduces rework.

As such, by automatically standardizing seeded semantic object models, evaluating custom object models, and/or transmitting notifications (e.g., error alert notification, error warning notification, recommendation for addressing an error) according to embodiments of the present disclosure, some embodiments of the present disclosure reduce the load on the system, reduces the load on personnel, increases computational efficiency associated with the system and client devices, and increases storage efficiency associated with the system and client devices.

### Definitions

In some embodiments, some of the operations above may be modified or further amplified. Furthermore, in some embodiments, additional optional operations may be included. Modifications, amplifications, or additions to the operations above may be performed in any order and in any combination.

The term “seeded semantic object model” refers to electronically managed data embodying a configuration of an object model and/or a collection of object models seeded with default classes, relations, and properties. For example, the seeded semantic object model may comprise an object model or collection of object models that are generable, storable, processable, and/or otherwise interactable within a system, and that is configured to enable updating of object types represented in the configuration of object models. In one example context, a seeded semantic object model includes different types of object models representing real world and/or hypothetical assets. In one or more embodiments, a seeded semantic object model may be stored by a centralized system and/or unalterable directly by any end-user. Additionally or alternatively, in some embodiments, a seeded semantic object model may be utilized to initiate an instance of an independent semantic object model that may be extendable by an end user, where the seeded semantic object model serves as a template for the instance of the independent semantic object model. A seeded semantic object model may embody or be associated with a knowledge graph that defines the semantics (or meta data) for a domain. For example, a seeded semantic object model may define the schema for a knowledge graph associated with the domain.

The terms “independent semantic object model” and “tenant semantic object model” may be used interchangeably to refer to electronically managed data embodying a configuration of object model and/or collection of object models representing a use case embodying a particular separately manageable instance of an extensible object model. For example, an independent semantic object model may comprise an object model or collection of object models that are generable, storable, processable, and/or otherwise interactable within a system, and that is configured to enable updating of object types represented in the configuration of object models. In one example context, an independent semantic object model includes different types of object models representing real world and/or hypothetical assets. In some embodiments, an independent semantic object model can be altered by an end user, and provides a flexible robust, and self-service modeling capability that allows an end user to independently manage object models. As one example, an instance of an independent semantic object model may comprise an extended seeded semantic object model. As another example, an instance of an independent semantic object model may comprise user-defined semantic object model not provided in the seeded semantic object model. An independent semantic object model may embody or be associated with a knowledge graph that defines the semantics (or meta data) associate with a particular user with respect to a domain. For example, an independent semantic object model may define the schema for a knowledge graph associated with a particular user with respect to a specific domain.

The term “knowledge graph” refers to a graph structure that describes object models and their interrelations. In one or more embodiments, a knowledge graph defines possible classes and relations of object models in a schema. As such, a knowledge graph may include large networks of object models, their object types, properties, and relationships between object models. In one or more embodiments, a knowledge graph includes or is otherwise associated with a seeded semantic object model and/or independent semantic object model. For example and without limitation, a subset of a knowledge graph may comprise data associated with independent semantic object model(s) and/or seeded semantic object model that defines semantics for the independent semantic object models and/or seeded semantic object models. For example, an independent semantic object model and/or seeded semantic object model may define the schema for a corresponding knowledge graph. In some embodiments, a user knowledge graph or at least a portion thereof may be built subject to constraints expressed in the independent semantic object model(s) associated with a user.

The term “object model” may refer to a data construct that represents entities, such as real world and/or hypothetical assets and structures. In some embodiments, object models may comprise building blocks of a seeded semantic object model and/or an independent semantic object model in which a user can create and customize entities (e.g., assets and structures) represented in the independent semantic object model. For example and without limitation, example object models may represent different buildings and/or sub-components or assets of such buildings. An object model may be defined by one or more attributes (also referred to as object attributes). In some embodiments, such attributes may include a class of the object type, relation links, that links two classes, one or more object properties, space, and/or the lic.

The term “object type” may refer to a categorization or classification of an object model or collection of object models that is determinable based at least in part on the attributes of the object model or attributes of the collection of object models. For example and without limitation an object type in one example context represents a particular entity from a grouping of entities (e.g., assets and structures), including and without limitation a pump, an HVAC unit, an elevator, a building, a department, and/or the like.

The term “similar object type” may refer to an object type that two or more independent semantic object models are determined to have in common (e.g., sufficiently similar or otherwise shared between two or more independent semantic object models), and where the set of attributes for each of the independent semantic object models for the particular object type is substantially similar. In one example embodiment, a similar object type includes an object type associated with a subset of independent semantic object models having at least substantially similar set of object properties.

The term “model updating criteria” may refer to a data construct that embodies one or more criteria that is used to determine whether a seeded semantic object model should be updated based on at least one identified similar object type. For example, in one or more embodiments, a similar object type is evaluated to determine if the similar object type satisfies a model updating criteria, for example, using a machine learning model and/or a rules-based engine. Non-limiting examples of a model updating criteria includes a certain percentage (e.g., pre-defined percentage) of a plurality of independent semantic object models 108A-108N having a similar object type, a minimum number of independent semantic object models having a similar object type, and/or the like.

### Example Systems and Apparatuses of the Disclosure

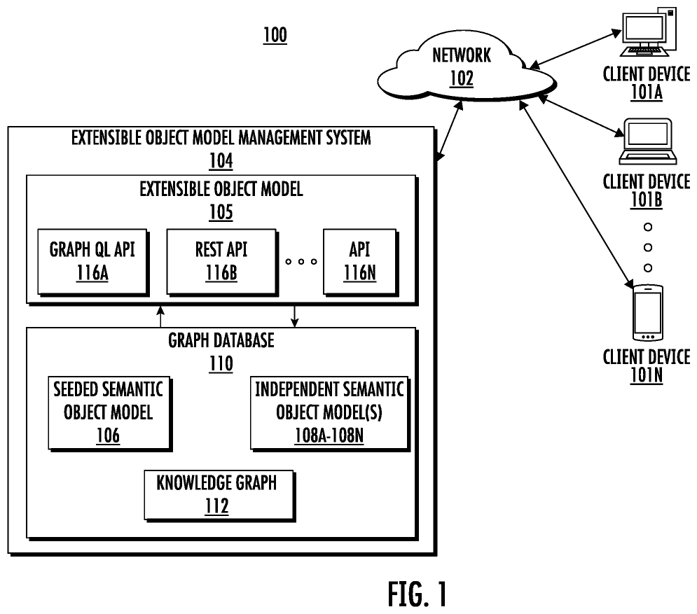

FIG. 1 illustrates a block diagram of a system that may be specially configured within which embodiments of the present disclosure may operate. Specifically, FIG. 1 depicts an example system 100. As illustrated, the system 100 includes at least one client device 101A-101N and an extensible object model management system 104 comprising an extensible object model 105 and a graph database 110. The graph database 110 comprises a seeded semantic object model 106 and at least one independent semantic object model 108A-108N. In some embodiments, the extensible object model management system 104 comprises multiple graph database 110. In some embodiments, a graph database 110 is associated with a user. In some embodiments, the extensible object model 105 embodies one or more application programming interfaces (API) 116A-116N. In some embodiments, the extensible object model 105 is in communication with a graph database 110. In some embodiments, a graph database 110 comprise at least one knowledge graph 112. In some embodiments, graph database 110 and/or the knowledge graph 112 may be a part of a separate system in communication with the extensible object model management system 104. In some embodiments, the extensible object model management system 104 and/or the client device 101A-101N are communicable over one or more communications network(s), for example the communications network 102.

It should be appreciated that the communications network 102 in some embodiments is embodied in any of a myriad of network configurations. In some embodiments, the communications network 102 embodies a public network (e.g., the Internet). In some embodiments, the communications network 102 embodies a private network (e.g., an internal, localized, or closed-off network between particular devices). In some other embodiments, the communications network 102 embodies a hybrid network (e.g., a network enabling internal communications between particular connected devices and external communications with other devices). The communications network 102 in some embodiments includes one or more base station(s), relay(s), router(s), switch(es), cell tower(s), communications cable(s) and/or associated routing station(s), and/or the like. In some embodiments, the communications network 102 includes one or more user controlled computing device(s) (e.g., a user owner router and/or modem) and/or one or more external utility devices (e.g., Internet service provider communication tower(s) and/or other devices.

Each of the components of the system communicatively coupled to transmit data to and/or receive data from another over the same or different wireless or wired networks embodying the communications network 102. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities communicating over the communications network 102, the various embodiments are not limited to this particular architecture. In other embodiments, one or more computing entities share one or more components, hardware, and/or the like, or otherwise are embodied by a single computing device such that connection(s) between the computing entities are over the communications network 102 are altered and/or rendered unnecessary.

The extensible object model management system 104 includes any number of computing device(s) that perform one or more function(s) for managing data in an extensible object model 105 and/or graph database 110, seeded semantic object model 106 and/or independent semantic object model 108A-108N, including storing data, communicating with the extensible object model 105, communicating with a graph database 110, communicating with a seeded semantic object model 106, communicating with an independent semantic object model 108A-108N, communicating with client device 101A-101N, identifying independent semantic object models 108A-108N, processing independent semantic object models 108A-108N to determine similar object types, and updating a seeded semantic object model 106 based at least in part on the similar object types. In some embodiments, a separate system from the extensible object model management system 104 performs the function(s) for managing data in accordance with particular parameters.

The seeded semantic object model 106 and/or independent semantic object model 108A-108N include a configuration of an object model or a collection of object models that are generable, sortable, processable, and/or otherwise interactable within a system, such as an extensible object model management system 104. In some embodiments, seeded semantic object model 106 and/or independent semantic object model 108A-108N include a configuration of an object model or a collection of object models that are generable, sortable, processable, and/or otherwise interactable within a system external to extensible object model management system 104. In one or more embodiments, seeded semantic object model 106 and independent semantic object model 108A-108N include a collection of JavaScript Object Notation Format object models configured to represent, for example and without limitation, physical or hypothetical assets and/or structures. In one or more embodiments, the extensible object model (e.g., one or more APIs 116A-116N thereof) enables the seeded semantic object model 106 and/or independent semantic object model 108A-108N to be extended.

Graph database 110 includes any number of computing device(s), embodying at least one repository, that perform one or more function(s) for storing object model(s) of a seeded semantic object model 106 and/or independent semantic object model 108A-108N. In one or more embodiments, graph database 110 stores a variety of data including node objects and relationships. In one or more embodiments, node objects and relationships are stored in graph database 110 in a nested or hierarchical structure. In one or more embodiments, at least a portion of the data stored by the graph database 110 includes a knowledge graph 112. In one or more embodiments, graph database 110 is remote to extensible object model management system 104. In one or more embodiments, graph database 110 is internal to extensible object model management system 104. In one or more embodiments, graph database 110 comprises a Neo4j instance. In one or more embodiments, graph database 110 embodies a plurality of graph databases, where each graph database embodied by the graph database 110 is associated with a particular user and embodies a seeded semantic object model 106, a knowledge graph 112 associated with the particular user, and/or one or more independent semantic object models 108A-108N associated with the particular user. For example, extensible object model management system 104 may comprise a plurality of graph database 110, where each graph database 110 is associated with a particular user and includes a seeded semantic object model 106, a knowledge graph 112 associated with the particular user, and/or one or more independent semantic object models associated with the particular user

Client device(s) 101A-101N includes one or more computing device(s) accessible to an end user. In some embodiments, the client device(s) 101A-101N comprise a personal computer, laptop, smartphone, tablet, Internet-of-Things enabled device, smart home device, virtual assistant, alarm system, and/or the like. The client device(s) 101A-101N may include a display, one or more visual indicator(s), on or more audio indicator(s), and/or the like that enables output to a user associated with the client device 101A-101N. In some embodiments, a client device embodies or is otherwise associated with a client system.

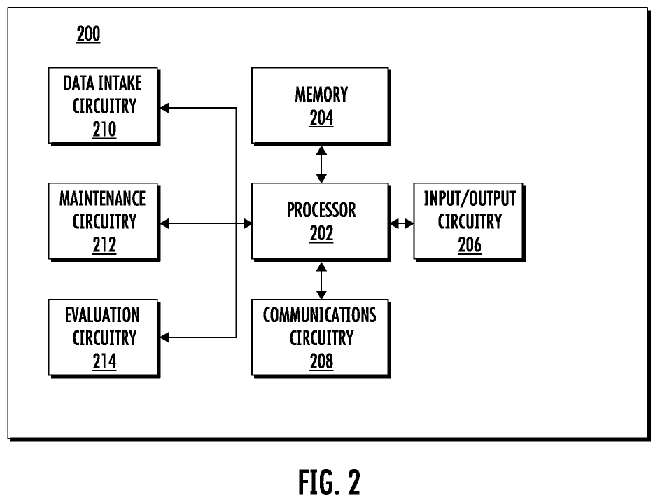

FIG. 2 illustrates a block diagram of an example apparatus that may be specially configured in accordance with at least some example embodiments of the present disclosure; Specifically, FIG. 2 depicts an example extensible object model management apparatus 200 specially configured in accordance with at least some example embodiments of the present disclosure. In some embodiments, the extensible object model management system 104 and/or a portion thereof is embodied by one or more system(s), such as the apparatus 200 as depicted and described in FIG. 2. The apparatus 200 includes processor 202, memory 204, input/output circuitry 206, communications circuitry 208, data intake circuitry 210, maintenance circuitry 212, and evaluation circuitry 214. In some embodiments, the apparatus 200 is configured, using one or more of the sets of circuitry 202, 204, 206, 208, 210, 212, and/or 214, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage the use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

In some example embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) and/or other hardware or software to cause transmission of signals via the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

The data intake circuitry 210 includes hardware, software, firmware, and/or a combination thereof, that supports receiving data associated with independent semantic object models 108A-108Ns. In some embodiments, the data intake circuitry 210 includes hardware, software, firmware, and/or a combination thereof, that identifies or otherwise detects an independent semantic object model event, such as creation of an independent semantic object model 108A-108N, modification of an independent semantic object model 108A-108N, execution of an independent semantic object model 108A-108N, and/or the like. The data intake circuitry 210 may communicate with client device 101A-101N, extensible object model management system 104, extensible object model 105, graph database 110, seeded semantic object model 106, independent semantic object model 108A-108N, and/or knowledge graph 112). Additionally or alternatively, in some embodiments, the data intake circuitry 210 includes hardware, software, firmware, and/or a combination thereof, that requests data from one or more client devices 101A-101N, extensible object model management system 104, extensible object model 105, graph database 110, seeded semantic object model 106, independent semantic object model 108A-108N, and/or knowledge graph 112. In some embodiments, the data intake circuitry 210 includes hardware, software, firmware, and/or a combination thereof, that stores received data in a database. The database, for example, may comprise graph database 110. In some embodiments, data intake circuitry 210 includes a separate processor, specially configured field programmable gate array (FPGA), or a specially programmed application specific integrated circuit (ASIC).

Maintenance circuitry 212 includes hardware, software, firmware, and/or a combination thereof that supports maintaining a seeded semantic object model 106. For example, in some embodiments, the maintenance circuitry 212 includes hardware, software, firmware, and/or a combination thereof that updates a seeded semantic object model 106 based on a plurality of independent semantic object models. As such, standardizing the seeded semantic object model 106 across at least one domain. In one or more embodiments, the maintenance circuitry 212 includes hardware, software, firmware, and/or a combination thereof that identifies a plurality of independent semantic object model 108A-108N. In some embodiments, the identified plurality of independent semantic object model 108A-108N may comprise independent semantic object model 108A-108N associated with a specified period. For example, in one or more embodiments, the maintenance circuitry 212 includes hardware, software, firmware, and/or a combination thereof that identifies independent semantic object models 108A-108N created and/or modified within a particular period (e.g., within the last 2 months, between Jan. 1, 2022 and Apr. 1, 2022, etc.). In one or more embodiments, the plurality of independent semantic object model 108A-108N comprise independent semantic object models 108A-108N that have at least one user-defined object type and/or at least one modified object type relative to the seeded semantic object model 106. For example, the maintenance circuitry 212 includes hardware, software, firmware, and/or a combination thereof that determines whether an independent semantic object model 108A-108N includes at least one user-defined object type and/or at least one modified object type relative to the seeded semantic object model 106. In one or more embodiments, a modified object type may comprise an extended object type from a seeded semantic object model 106. In one or more embodiments, an object type describes an object model representing an entity associated with an enterprise (e.g., company, corporation, building, industrial plant, etc.). In an example context, an entity may comprise an asset associated with an enterprise. Such assets may include devices, equipment, processes, systems, etc. An object type may be defined by one or more attributes. In one or more embodiments, an attribute may include a class of the object type, relation links linking two classes, object properties of the object type, and/or the like. In some embodiments, the maintenance circuitry 212 includes hardware, software, firmware, and/or a combination thereof, that determines an identifier (e.g., user identifier) associated with each independent semantic object model 108A-108N of a plurality of independent semantic object models 108A-108N.

In one or more embodiments, the maintenance circuitry 212 includes hardware, software, firmware, and/or a combination thereof that identifies the object type(s) associated with an independent semantic object model 108A-108N. The independent semantic object model 108A-108N may comprise an independent semantic object model 108A-108N associated with a particular period. Additionally or alternatively, the maintenance circuitry 212 includes hardware, software, firmware, and/or a combination thereof that identifies attributes (e.g., class, relation links, object properties, and/or the like) associated with an independent semantic object model 108A-108N. Additionally or alternatively, the maintenance circuitry 212 includes hardware, software, firmware, and/or a combination thereof that processes the object types associated with a plurality of independent semantic object models 108A-108N to determine similar object types. In one or more embodiments, a similar object type describes an object type that is shared between at least a subset of the plurality of independent semantic object models 108A-108N. For example, a similar object type may comprise an object type associated with a subset of independent semantic object models 108A-108N having substantially similar attribute(s) with respect to each of the independent semantic object model 108A-108N in the subset of independent semantic object models 108A-108N.

In some embodiments, a similar object type may comprise an object type associated with a subset of independent semantic object models 108A-108N having at least substantially similar set of object properties. In some example embodiments, the maintenance circuitry 212 includes hardware, software, firmware, and/or a combination thereof that process a plurality of independent semantic object models 108A-108N to generate at least one similarity score based on one or more attributes (e.g., object properties, relation links, and/or the like) of each independent semantic object model 108A-108N of the plurality of independent semantic object models 108A-108N. In some embodiments, the maintenance circuitry 212 includes hardware, software, firmware, and/or a combination thereof, that support one or more of a variety of techniques for generating a similarity score based on one or more attributes of each independent semantic object model 108A-108N. Such techniques may include cosine similarity technique, Euclidean distance technique and/or the like. In some embodiments, the maintenance circuitry 212 includes hardware, software, firmware, and/or a combination thereof, that determines one or more independent semantic object model clusters, where each independent semantic object model cluster comprises a subset of a plurality of independent semantic object models 108A-108N having at least one object type in common. In some embodiments, the maintenance circuitry 212 includes hardware, software, firmware, and/or a combination thereof, that generates a similarity score for each independent semantic object model cluster based at least in part on one or more attributes (e.g., object properties, relation links, and/or the like). In some embodiments, the maintenance circuitry 212 includes hardware, software, firmware, and/or a combination thereof, that determines whether a similarity score satisfies a similarity score threshold, where an object type associated with a similarity score that satisfies the similarity score threshold is deemed a similar object type.

Additionally or alternatively, in some embodiments, the maintenance circuitry 212 includes hardware, software, firmware, and/or a combination thereof, that support one or more machine learning models to determine a similar object type based at least in part on the plurality of independent semantic object models 108A-108Ns. In some embodiments, the maintenance circuitry 212 includes hardware, software, firmware, and/or a combination thereof, that trains one or more machine learning models to determine a similar object type based at least in part on a plurality of independent semantic object models 108A-108N. In some embodiments, the training data for training the one or more machine learning models may include historical data associated with past instances of independent semantic object models 108A-108N and/or knowledge graphs 112. Additionally or alternatively, in some embodiments, the maintenance circuitry 212 includes hardware, software, firmware, and/or a combination thereof, that support a rules based engine to determine a similar object type based at least in part on the plurality of independent semantic object models 108A-108Ns.

In some embodiments, the maintenance circuitry 212 includes hardware, software, firmware, and/or a combination thereof that determines whether similar object types(s) shared between at least a subset of a plurality of independent semantic object models 108A-108N satisfies model updating criteria. In some embodiments, the maintenance circuitry 212 includes hardware, software, firmware, and/or a combination thereof, that support a machine learning model to determine whether similar object types(s) shared between at least a subset of a plurality of independent semantic object models 108A-108N satisfies model updating criteria. In some embodiments, the maintenance circuitry 212 includes hardware, software, firmware, and/or a combination thereof, that trains one or more machine learning models to determine whether similar object types(s) shared between at least a subset of a plurality of independent semantic object models 108A-108N satisfies model updating criteria. In some embodiments, the training data for training the one or more machine learning models may include historical data associated with past instances of independent semantic object models 108A-108N and/or knowledge graphs 112. Additionally or alternatively, in some embodiments, the maintenance circuitry 212 includes hardware, software, firmware, and/or a combination thereof, that support a rules based engine to determine whether similar object types(s) shared between at least a subset of a plurality of independent semantic object models 108A-108N satisfies model updating criteria. In some embodiments, the model updating criteria includes a certain percentage (e.g., defined percentage) of the plurality of independent semantic object models 108A-108N having a similar object type with respect to a particular object type (e.g., pump, HVAC, building, etc.). Additionally or alternatively, in some embodiments, the model updating criteria includes a minimum number of independent semantic object models having a shared similar object type (e.g., minimum of 20 independent semantic object model 108A-108Ns, minimum of 250 independent semantic object models 108A-108N, and/or the like).

Additionally or alternatively, in some embodiments, the model updating criteria includes a minimum number of user identifiers associated with the subset of independent semantic object models 108A-108N having a similar object type.

Additionally and/or alternatively, in some embodiments, the maintenance circuitry 212 includes hardware, software, firmware, and/or a combination thereof that updates a seeded semantic object model 106 based on at least one qualifying similar object type. A qualifying similar object type may describe a similar object type determined to satisfy model updating criteria. In some embodiments, updating a seeded semantic object model 106 comprises at least one of generating, within a seeded semantic object model 106, an additional object type corresponding to a qualifying similar object type. Additionally or alternatively, updating a seeded semantic object model comprises modifying, within a seeded semantic object model 106, an existing object type. For example, in some embodiments, the maintenance circuitry 212 includes hardware, software, firmware, and/or a combination thereof that generates, within the seeded semantic object model 106, an additional object type corresponding to a qualifying similar object type. As another example, in some embodiments, the maintenance circuitry 212 includes hardware, software, firmware, and/or a combination thereof that modifies, within the seeded semantic object model 106, an existing object type (e.g., adding a new property, changing a property, adding a relation link, changing a relation link, and/or the like). In some embodiments, the maintenance circuitry 212 includes a separate processor, specially configured field programmable gate array (FPGA), or a specially programmed application specific integrated circuit (ASIC).

The evaluation circuitry 214 includes hardware, software, firmware, and/or a combination thereof, that supports various functionality associated with supporting an instance of an independent semantic object model 108A-108N. For example, the evaluation circuitry 214 includes hardware, software, firmware, and/or a combination thereof, that support in real-time or near real-time an instance of an independent semantic object model 108A-108N that includes extending a seeded semantic object model 106 (e.g., adding properties, adding relation links, and/or the like to an existing object type). As another example, the evaluation circuitry 214 includes hardware, software, firmware, and/or a combination thereof, that support in real-time or near real-time generation of an independent semantic object model that includes defining additional object type. The evaluation circuitry 214 may communicate with client device(s) 101A-101N, extensible object model 105, graph database 110, seeded semantic object model 106, independent semantic object model 108A-108N, knowledge graph 112, and/or extensible object model management system 104. Additionally or alternatively, in some embodiments, the evaluation circuitry 214 includes hardware, software, firmware, and/or any combination thereof that evaluates, in real-time or near real-time, object type(s) associated with an instance of an independent semantic object model 108A-108N. For example, in some embodiments, the evaluation circuitry 214 includes hardware, software, firmware, and/or any combination thereof that evaluates, in real-time or near real-time attributes of an object type. Additionally or alternatively, in some embodiments, the evaluation circuitry 214 includes hardware, software, firmware, and/or any combination thereof that determines an instantiation condition indicative of error(s) and/or potential issue(s) with respect to an instance of an independent semantic object model 108A-108N (e.g., an instance of an object type associated with an independent semantic object models 108A-108Ns).

Additionally or alternatively, in some embodiments, the evaluation circuitry 214 includes hardware, software, firmware, and/or any combination thereof, that transmits one or more notifications (e.g., an alert notification, a warning notification, a recommendation/suggestion notification, a corrective action notification, and/or the like) to a client device 101A-101N in response to a detected instantiation condition. Additionally or alternatively, in some embodiments, the evaluation circuitry 214 includes hardware, software, firmware, and/or any combination thereof, that identifies response to a notification, for example, based at least in part on re-evaluating the independent semantic object model 108A-108N (e.g., re-evaluating an object type associated with the notification). Additionally or alternatively, in some embodiments, the evaluation circuitry 214 includes hardware, software, firmware, and/or any combination thereof, that enables continuous monitoring of data associated with instances of independent semantic object model 108A-108N. In some embodiments, the evaluation circuitry 214 includes hardware, software, firmware, and/or any combination thereof, that stores response to a notification in a database associated with the extensible object model management system 104. In some embodiments, the evaluation circuitry 214 includes a separate processor, specially configured field programmable gate array (FPGA), or a specially programmed application specific integrated circuit (ASIC).

Additionally or alternatively, in some embodiments, two or more of the sets of circuitries 202-214 are combinable. Alternatively or additionally, in some embodiments, one or more sets of circuitry perform some or all of the functionality described associated with another component. For example, in some embodiments, two or more of the sets of circuitry 202-214 are combined into a single module embodied in hardware, software, firmware, and/or a combination thereof. Similarly, in some embodiments, one or more of the sets of circuitry, for example the data intake circuitry 210, the maintenance circuitry 212, and/or the evaluation circuitry 214, is/are combined with the processor 202, such that the processor 202 performs one or more of the operations described above with respect to each of these sets of circuitry 202-214.

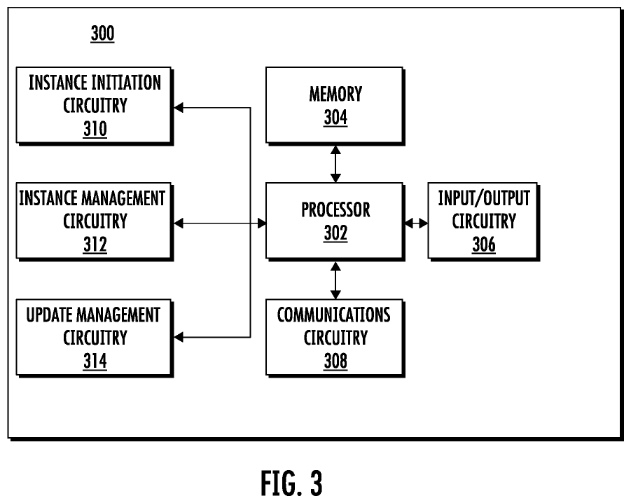

FIG. 3 illustrates a block diagram of an example apparatus embodying a client system in accordance with at least one embodiment of the present disclosure. Specifically, FIG. 3 illustrates an example client apparatus 300 (“apparatus 300”) specifically configured in accordance with at least one example embodiment of the present disclosure. In some embodiments the client system is embodied by one or more system(s), device(s), and/or the like, such as the apparatus 300 as depicted and described in FIG. 3. In some embodiments, each of the client devices 101A-101N are embodies a corresponding client system and/or or is associated with a corresponding client system as described herein. The apparatus 300 includes processor 302, memory 304, input/output circuitry 306, communications circuitry 308, instance initiation circuitry 310, instance management circuitry 312, and update management circuitry 314. In some embodiments, the apparatus 300 is configured, using one or more of the processor 302, memory 304, input/output circuitry 306, communications circuitry 308, instance initiation circuitry 310, instance management circuitry 312, and update management circuitry 314, to execute and perform one or more of the operations described herein.

In some embodiments, the processor 302, memory 304, input/output circuitry 306, and communications circuitry 308, function similarly or identically to the similarly named sets of circuitry embodying processor 202, memory 204, input/output circuitry 206, and communications circuitry 208 as depicted and described with respect to the apparatus 200 in FIG. 2. Additionally or alternatively, in some embodiments, the processor 302 includes hardware, software, firmware, and/or a combination thereof, that supports functionality performed by the client systems as depicted and described with respect to FIG. 1. For example, in some embodiments, the processor 302 includes hardware, software, firmware, and/or a combination thereof, that supports initiation, maintenance, and/or use of an independent semantic object model based on a seeded semantic object model. The seeded semantic object model may serve as a template for generating instances of an independent semantic object model. For purposes of brevity, repeated disclosure with respect to the functionality of such similarly-named sets of circuitry is omitted herein.

In some embodiments, the apparatus 300 includes instance initiation circuitry 310. The instance initiation circuitry 310 includes hardware, software, firmware, and/or a combination thereof, that supports generation of a new independent semantic object model (e.g., new independent semantic object model instance) based at least in part on a seeded semantic object model that serves as a template and/or a reference. For example, in some embodiments, the instance initiation circuitry 310 includes hardware, software, firmware, and/or a combination thereof, that receives a selection of a seeded semantic object model for use (e.g., as a template).

The instance initiation circuitry 310 includes hardware, software, firmware, and/or a combination thereof, that supports generation and use of a seeded semantic object model as a template. For example, in some embodiments, the instance initiation circuitry 310 includes hardware, software, firmware, and/or a combination thereof, that causes rendering of a user interface for selecting a seeded semantic object model template. Additionally or alternatively, in some embodiments, the instance initiation circuitry 310 includes hardware, software, firmware, and/or a combination thereof, that receives instance information for use in initiating a new instance of independent semantic object model. Additionally or alternatively, in some embodiments, the instance initiation circuitry 310 includes hardware, software, firmware, and/or a combination thereof, that configures an independent semantic object model based at least in part on the independent semantic object model instance. In some embodiments, instance initiation circuitry 310 includes a separate processor, specially configured field programmable gate array (FPGA), or a specially programmed application specific integrated circuit (ASIC).

Additionally, in some embodiments the apparatus 300 includes instance management circuitry 312. The instance management circuitry 312 includes hardware, software, firmware, and/or a combination thereof, that supports storing and use of independent semantic object model(s) (e.g., independent semantic object model instance(s)). For example, in some embodiments, the instance management circuitry 312 includes hardware, software, firmware, and/or a combination thereof, that maintains access to independent semantic object model(s) associated with a particular client system. Additionally or alternatively, in some embodiments, the instance management circuitry 312 includes hardware, software, firmware, and/or a combination thereof, that collects, processes, and/or communicates data from a connected device, for example a third-party device, utilizing at least one independent semantic object model. Additionally or alternatively, in some embodiments, the instance management circuitry 312 includes hardware, software, firmware, and/or a combination thereof, that provides access to instance information associated with particular independent semantic object model instance(s). Additionally or alternatively, in some embodiments, the instance management circuitry 312 includes hardware, software, firmware, and/or a combination thereof, that enables activation, deactivation, and/or reconfiguration of one or more independent semantic object models. In some embodiments, instance management circuitry 312 includes a separate processor, specially configured field programmable gate array (FPGA), or a specially programmed application specific integrated circuit (ASIC).

Additionally, in some embodiments the apparatus 300 includes update management circuitry 314. The update management circuitry 314 includes hardware, software, firmware, and/or a combination thereof, that supports updating of independent semantic object models. For example, in some embodiments, the update management circuitry 314 includes hardware, software, firmware, and/or a combination thereof, that receives update request(s) and/or notification(s) associated with a particular independent semantic object model instance. Additionally or alternatively, in some embodiments, the update management circuitry 314 includes hardware, software, firmware, and/or a combination thereof, that receives updated information associated with a particular independent semantic object model instance. Additionally or alternatively, in some embodiments, the update management circuitry 314 includes hardware, software, firmware, and/or a combination thereof, that updates an independent semantic object model based at least in part on received updated information and/or notification. Additionally or alternatively, in some embodiments, the update management circuitry 314 includes hardware, software, firmware, and/or a combination thereof, that maintains and/or provides access to an instance action log associated with a particular independent semantic object model instance, where the instance action log represents configuration changes, updates, and/or other changes to the independent semantic object model. In some embodiments, update management circuitry 314 includes a separate processor, specially configured field programmable gate array (FPGA), or a specially programmed application specific integrated circuit (ASIC). Additionally or alternatively, in some embodiments, the update management circuitry 314 includes hardware, software, firmware, and/or a combination thereof, that updates a knowledge graph associated with a particular independent semantic object model instance.

Additionally or alternatively, in some embodiments, two or more of the sets of circuitries embodying processor 302, memory 304, input/output circuitry 306, communications circuitry 308, instance initiation circuitry 310, instance management circuitry 312, and/or update management circuitry 314. Alternatively or additionally, in some embodiments, one or more of the sets of circuitry perform some or all of the functionality described associated with another component. For example, in some embodiments, two or more of the sets of circuitry embodied by processor 302, memory 304, input/output circuitry 306, communications circuitry 308, instance initiation circuitry 310, instance management circuitry 312, and/or update management circuitry 314, are combined into a single module embodied in hardware, software, firmware, and/or a combination thereof. Similarly, in some embodiments, one or more of the sets of circuitry, for example instance initiation circuitry 310, instance management circuitry 312, and/or update management circuitry 314, is/are combined with the processor 302, such that the processor 302 performs one or more of the operations described above with respect to each of these sets of circuitry embodied by the instance initiation circuitry 310, instance management circuitry 312, and/or update management circuitry 314.

### Example Data Environments and Architectures of the Disclosure

Having described example systems and apparatuses of the disclosure, example data architectures, data environments, and data flows will now be described. In some embodiments, the data architectures represent data object(s) maintained and processed in in particular computing environments. In some embodiments, the computing environment(s) is/are maintained via hardware, software, firmware, and/or a combination thereof, that execute one or more software application(s) that manage such data. For example, in some embodiments, the apparatus 200 and/or apparatus 300 execute one or more software application(s) that maintain the data architecture(s) as depicted and described to, alone or in conjunction with one another, perform the functionality as depicted and described with respect to seeded semantic object model template generation, provision and/or use, and/or independent semantic object model generation and/or use.

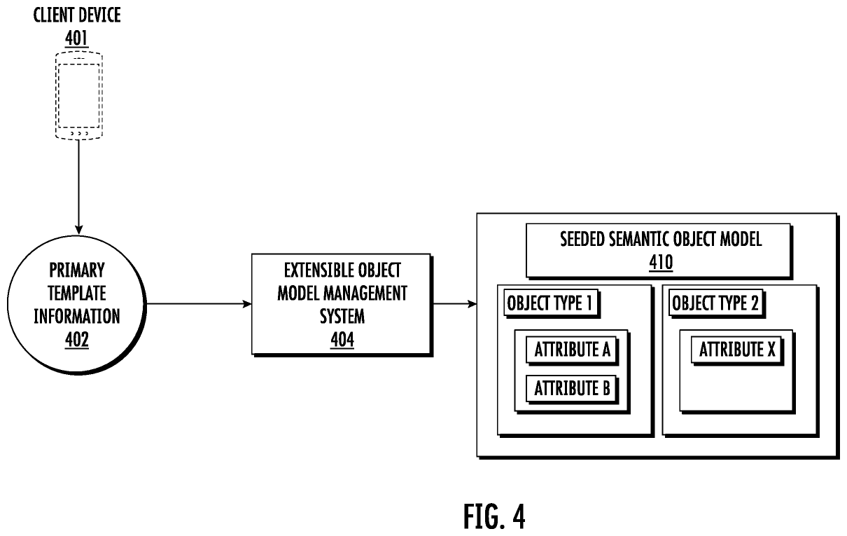

FIG. 4 illustrates a visualization of an example data environment for providing seeded semantic object model, for example, as a template in accordance with at least one embodiment of the present disclosure. As described above a seeded semantic object model may serve as a template for generating instances of independent semantic object models. Specifically, the data environment for generating the seeded semantic object model is performed by extensible object model management system 404. The extensible object model management system 404 may embody a particular implementation of the extensible object model management system 104 as depicted and described herein. For example, in some embodiments, the extensible object model management system is embodied by the apparatus 200 as depicted and described herein. In some embodiments, the extensible object model management system 404 causes rendering of, or otherwise provides access to, one or more user interfaces specially configured to enable inputting of the particular data portions as depicted and described herein.

As illustrated, the extensible object model management system 404 receives primary template information 402. In some embodiments, the primary template information 402 includes particular portions of template information required by the extensible object model management system 404 to provide and/or render a corresponding seeded semantic object model template. In some embodiments, the primary template information 402 includes schema information utilized to generate and/or otherwise select the corresponding seeded semantic object model template. In some embodiments, the primary template information 402 is received from client device 401.

Upon receiving all expected data, the extensible object model management system 404 selects and provides the appropriate seeded semantic object model 410 (e.g., as a template). In some embodiments, the seeded semantic object model 410 is selected and provided based at least in part on the inputted data received at earlier steps. In some embodiments, the seeded semantic object model 410 is configured to enable initiation of independent semantic object model instance(s) that perform data transformations, modeling, simulations, and/or other functionalities. In some embodiments, the seeded semantic object model 410 may be utilized to initiate a corresponding instance of an independent semantic object model that is automatically configured based at least in part on the seeded semantic object model 410 (e.g., serving as a template), and subsequently further configurable and/or alterable separate from other independent semantic object model instances associated with the seeded semantic object model template. In some embodiments, the extensible object model management system 404 stores the seeded semantic object model template in one or more data repository/repositories accessible to an end user, such that the seeded semantic object model template may be accessed, browsed, searched, and/or otherwise identified and selected for use in initiation of a corresponding independent semantic object model instance. In some embodiments, the seeded semantic object model template (e.g., seeded semantic object model that serves as a template) includes one or more object types. In some embodiments, each object type is defined by or otherwise includes one more attributes (e.g., also referred to as object attributes).

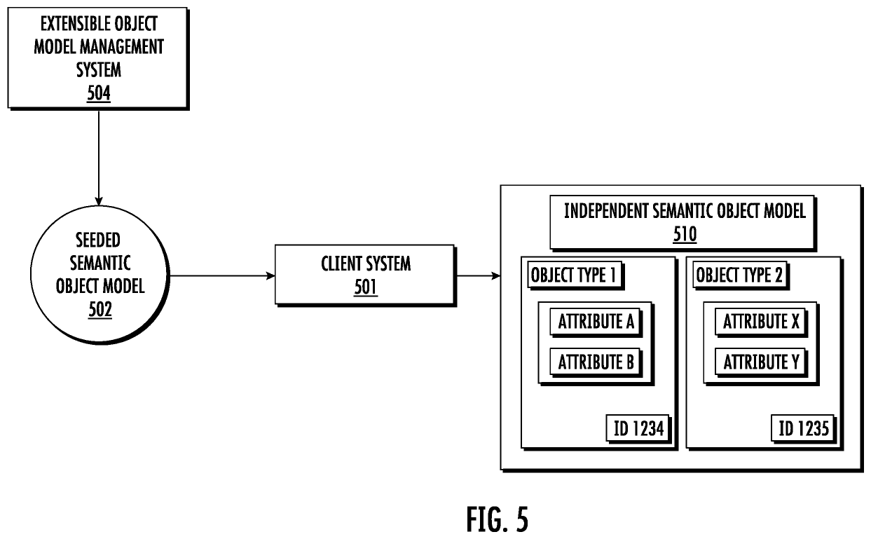

FIG. 5 illustrates a visualization of an example data environment for initiating independent semantic object models instance(s) in accordance with at least one embodiment of the present disclosure. Specifically, the data environment for initiating the independent semantic object model instance is performed by a client system 501. The client system 501 may embody a particular implementation of one of a client systems client system as depicted and described herein. For example, in some embodiments, the client system is embodied by the apparatus 300 as depicted and described herein. In some embodiments, the client system 501 causes rendering of, or otherwise provides access to, one or more user interfaces specially configured to enable inputting of the particular data portions as depicted and described herein.

As illustrated, the client system 501 receives seeded semantic object model 502 (e.g., seeded semantic object model template 502). In some embodiments, the extensible object model management system 504 receives the seeded semantic object model template from a particular extensible object model management system, for example, extensible object model management system 504. In some embodiments, the extensible object model management system 504 embodies a particular implementation of the extensible object model management system 404. The extensible object model management system 504 may store and/or otherwise maintain any number of seeded semantic object models templates (e.g., seeded semantic object models that serve as templates), each seeded semantic object model template selectable to create or otherwise initiate a new independent semantic object model based at least in part on the seeded semantic object model template. In this regard, in some embodiments a user of the client system 501 selects a particular seeded semantic object model template that fits a particular use case intended for the new independent semantic object model instance, for example based at least in part on a corresponding intended third-party device associated with the seeded semantic object model template, source schema data and/or target schema data that matches or is similar to the user's particular use case for the new independent semantic object model instance, and/or the like. In one or more circumstances, a seeded semantic object model template may perfectly match a user's particular use case, such that independent semantic object model instances need not undergo further customization to function properly. In some embodiments, each independent semantic object model includes one or more object types. Each object type is defined by or otherwise includes one more attributes (e.g., object attributes).

Additionally or alternatively, in some embodiments, the client system 501 includes one or more optional and/or additional data portions. For example, in some embodiments, the client system 501 receives an instance key (not shown) that is utilized to specially configure, authenticate, and/or otherwise authorize the access of the new independent semantic object models. In some embodiments, the client system 501 initiates the independent semantic object model 510 (e.g., independent semantic object model instance). In this regard, the initiation of the independent semantic object model 510 in some embodiments represents generation of one or more object model, application, and/or the like, specially configured based at least in part on the received inputted data. In some embodiments, the client system 501 stores and/or otherwise maintains the independent semantic object model 510, for example together with any number of independent semantic object model instances utilized by the client system 501. Alternatively or additionally, in some embodiments, the extensible object model management system 504 maintains the independent semantic object model(s) associated with the client system 501. For example, in some embodiments, the extensible object model management system 504 and the client system 501 are embodied by one system and/or platform that provides cloud-based functionality to an end-user. In some embodiments, the client system 501 is communicable or otherwise connected to one or more device(s) of an industrial system (not depicted), for example connected to particular sensor(s), third-party monitoring device(s), and/or sub-system(s) thereof, such that the independent semantic object model instance 510 and/or other initiated independent semantic object model instances are usable to monitor particular data via such connection(s).

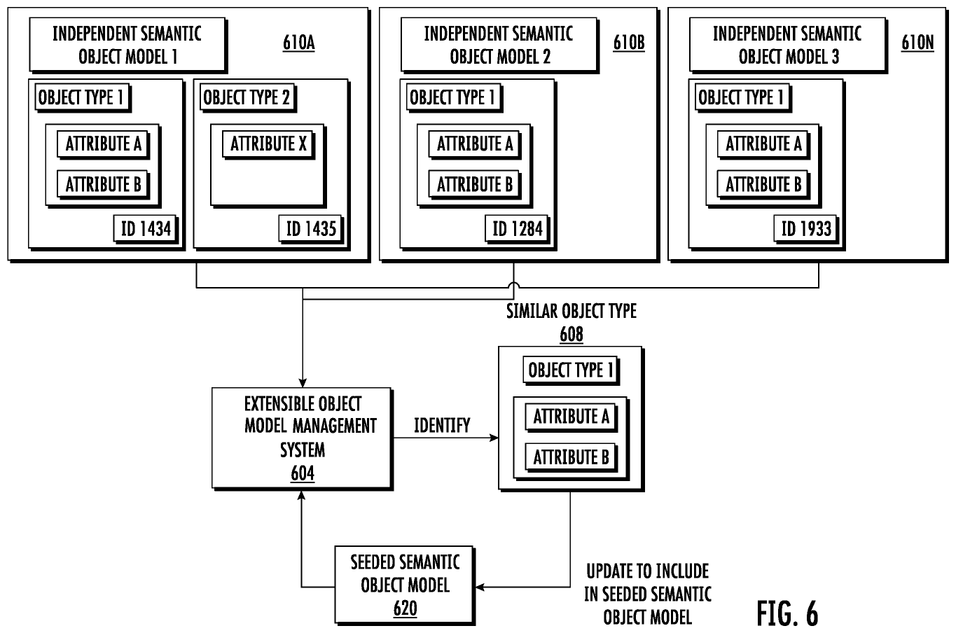

FIG. 6 illustrates a visualization of an example data environment for updating seeded semantic object models in accordance with at least one embodiment of the present disclosure. As described above a seeded semantic object model may serve as a template for generating instances of independent semantic object models. Specifically, the data environment for updating the seeded semantic object model is performed by extensible object model management system 604. The extensible object model management system 604 may embody a particular implementation of the extensible object model management system 104 as depicted and described herein. For example, in some embodiments, the extensible object model management system is embodied by the apparatus 200 as depicted and described herein. In some embodiments, the extensible object model management system 604 updates or causes updating of one or more seeded semantic object model (e.g., seeded semantic object model templates) as depicted and described herein.

The extensible object model management system 604 may retrieve independent semantic object models 610A-610N stored in a repository, such as the repository described above. In some embodiments, the extensible object model management system 604 retrieves independent semantic object models 610A-610N that satisfies one or more criteria. For example, in some embodiments, the extensible object model management system 604 retrieves independent semantic object models generated and/or updated within a specified period. For example, the extensible object model management system 604 may identify independent semantic object models generated and/or updated by a client device within the last 2 months, within the last 6 months, and/or the like.

Additionally or alternatively, in some embodiments, the extensible object model management system 604 retrieves independent semantic objects that have at least one user-defined object type and/or at least one modified object type relative to a corresponding seeded semantic object model. For example, in some embodiments, the extensible object model management system 604 retrieves independent semantic object models that do not match the corresponding seeded semantic object model based on the independent semantic object models having undergone customization (e.g., by a user). In some embodiments, a customized object type may comprise a user-defined object type that is not part on the seeded semantic object model or may comprise a modified object type. In some embodiments, the extensible object model management system 604 determines independent semantic object model that do not match corresponding seeded semantic object models based on the object attributes associated with the seeded semantic object model and the particular independent semantic object model. For example, in some embodiments, the extensible object model management system 604 compares object attributes of an independent semantic object model to a corresponding seeded semantic object model to determine if the seeded semantic object model and the independent semantic object model match.

The extensible object model management system 604 processes the object types associated with the retrieved independent semantic object models 610A-610N, based at least in part on the attributes associated with each object type, to identify at least one similar object type 608. In some embodiments, a similar object type comprise an object type that is shared between at least a subset of the retrieved independent semantic object models in that the subset of the retrieved independent semantic object model have a particular object type in common with substantially similar object attributes. In some embodiments, the extensible object model management system 604 utilizes a machine learning model and/or a rules base engine in identifying the at least one similar object type 608.

Upon identifying similar object type 608, the extensible object model management system 604 determines whether the similar object type satisfies model updating criteria. In some embodiments, the model updating criteria includes one or more of certain percentage (e.g., pre-defined percentage) of the retrieved independent semantic object models 610A-610N having a similar object type with respect to a particular object type, a minimum number of independent semantic object models having the similar object type, a minimum number of user identifiers associated with the subset of independent semantic object models having a similar object type, and/or the like.

Upon determining that the at least one similar object type 608 satisfies model updating criteria, the extensible object model management system 604, updates the seeded semantic object model 620 based at least in part on the at least one similar object type 608. In some embodiments, updating a seeded semantic object model 620 includes at least one of generating, within the seeded semantic object model 620, an additional object type corresponding to the similar object type; modifying, within a seeded semantic object model 620, an existing object type and/or replacing, within the seeded semantic object model 620, an existing object type with an object type corresponding to the at least one similar object type 608.

### Example Processes of the Disclosure

Having described example systems and apparatuses, in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. Similarly, it should be appreciated that one or more of the operations of each flowchart may be combinable, replaceable, and/or otherwise altered as described herein.

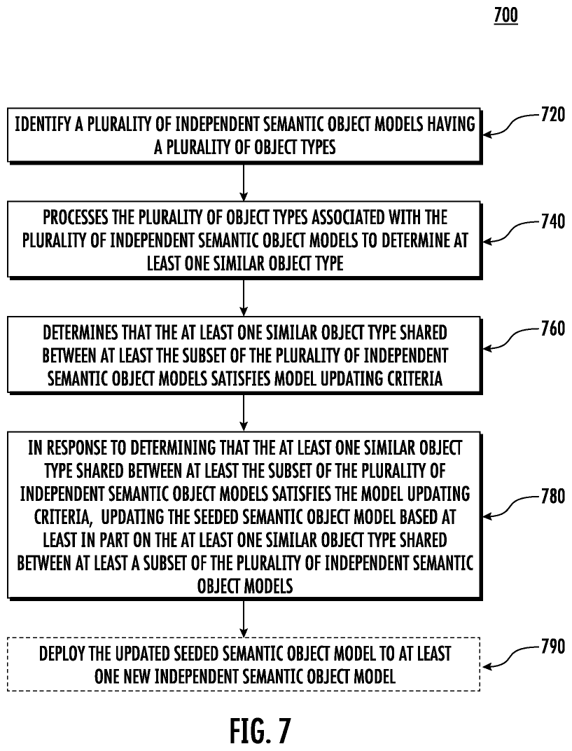

FIG. 7 illustrates a block diagram of an example apparatus embodying a client system in accordance with at least one embodiment of the present disclosure. FIG. 7 depicts operations of an example process 700. In some embodiments, the process 700 is embodied by a computer program code stored on a non-transitory computer-readable storage medium of a computer program product configured for execution to perform the process as depicted and described. Alternatively or additionally, in some embodiments, the process 700 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, at least one sensor associated with the at least one apparatus, at least one end-user computing device, and/or in some embodiments an optional external control system. For purposes of simplifying the description, process 700 is described as performed by and from the perspective of the apparatus 200.

The process 700 begins at operation 720. At operation 720, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that identifies a plurality of independent semantic object models having a plurality of object types. For example, each independent semantic object model may comprise one or more object types. In some embodiments, each object type is defined by a respective set of object attributes. In some embodiments, the set of attributes for a given object type may include a class of the object type, one or more relation links, one or more object properties of the object type, and/or the like. In some embodiments, the plurality of independent semantic object models is independently customizable by at least one user. In some embodiments, each independent semantic object model is associated with an identifier, such as a user identifier. A user identifier may describe one or more items of data by which a user associated with an independent semantic object model may be uniquely identified. For example, a user identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

In some embodiments, the apparatus 200 identifies the plurality of independent semantic object models based on independent semantic object models stored in a database. In some embodiments the apparatus 200 may include means such as the data intake circuitry 210, the maintenance circuitry 212, the evaluation circuitry 214, the communications circuitry 208, the input/output circuitry 206, the processor 202, and or the like, or a combination thereof, that identifies or otherwise detects an independent semantic object model event (e.g., an instance of an independent semantic object model, modification of an independent semantic object model, execution of an independent semantic object model, and/or the like), and stores data associated with the independent semantic object model event in the database associated with the apparatus 200. In some embodiments, data associated with an independent semantic object model and stored in a database include the object type(s) embodied by the independent semantic object model. Additionally or alternatively, in some embodiments, data associated with an independent semantic object model and stored in a database include attributes (e.g., class, relation link(s), propert(ies), space, and/or the like) of the object type(s) associated with the independent semantic object model. Additionally or alternatively, in some embodiments data associated with an independent semantic object model and stored in a database may include metadata associated with an independent semantic object model event. Such metadata may include timestamp(s) that reflects/describes when the independent semantic object model and/or associated object type(s) was created, modified, and/or the like. In some embodiments, data associated with an independent semantic object model event may be received by the apparatus 200 from a client device. In some embodiments, data associated with an independent semantic object model event may be stored in the database by the client device. In some embodiments, identifying the plurality of independent semantic object models comprise identifying semantic object models associated with a specified period (e.g., within the last 2 months, between Jan. 1, 2022 and Apr. 1, 2022, etc.). For example, the apparatus 200 may be configured to identify independent semantic object models associated with an independent semantic object model event that occurred with the specified period. In some embodiments, the apparatus 200 is configured to periodically identify a plurality of independent semantic object models. In one or more embodiments, the plurality of independent semantic object models comprise independent semantic object models that have at least one user-defined object type and/or at least one modified object type relative to a seeded semantic object model. For example, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that identifies a plurality of independent semantic object models that have at least one user-defined object type and/or at least one modified object type relative to a seeded semantic object model.

At operation 740, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that processes the plurality of object types associated with the plurality of independent semantic object models to determine at least one similar object type. In some embodiments, the apparatus 200 may determine the at least one similar object type based at least in part on the respective set of object attributes for each of the plurality of object types. In one or more embodiments, a similar object type comprise an object type that is shared between at least a subset of the plurality of independent semantic object models. A similar object type may comprise an object type associated with a subset of independent semantic object models having substantially similar attribute(s) with respect to each of the independent semantic object models in the subset of independent semantic object models. In some embodiments, a similar object type may comprise an object type associated with a subset of independent semantic object models having at least substantially similar set of object properties with respect to each of the independent semantic object models in the subset of independent semantic object models.

In one or more embodiments, the at least one similar object type is determined using a machine learning model. In some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that, that trains one or more machine learning models to determine a similar object type based at least in part on a plurality of independent semantic object models. In some embodiments, the training data for training the one or more machine learning models include historical data associated with past instances of independent semantic object models and/or knowledge graphs associated with the independent semantic object models (e.g., user identifiers thereof). Additionally or alternatively, in one or more embodiments, the at least one similar object type is determined using a rules-based engine. For example, a machine learning model and/or a rules-based engine may be configured, trained, and/or the like to determine the similar object type(s) based at least in part on the attributes of object models (e.g., based on the object properties, based on object models having similar relationship patterns between the object models, and/or the like)

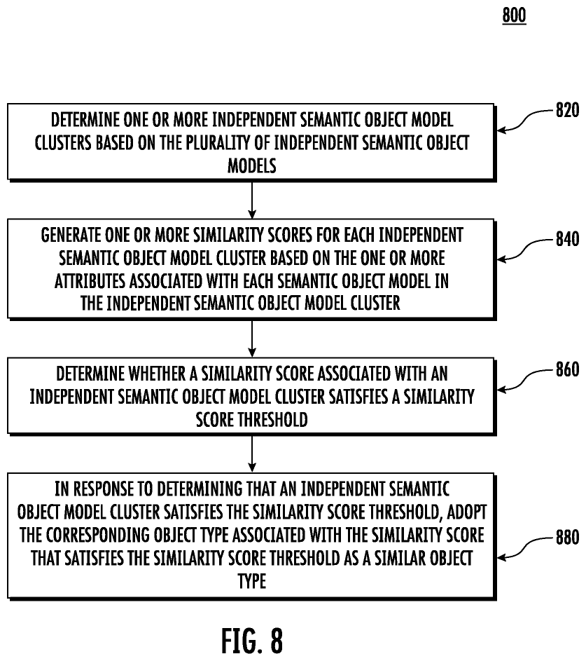

In one or more embodiments, the operation 740 may be performed in accordance with the process 800 that is depicted in FIG. 8, which is a process for determining at least one similar object type based at least in part on a similarity measure.

FIG. 8 illustrates a flowchart depicting operations of an example process for determining similar object type(s) in accordance with at least some example embodiments of the present disclosure. Specifically, FIG. 8 depicts operations of an example process 800. In some embodiments, the process 800 is embodied by a computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, at least one sensor associated with the at least one apparatus, at least one end-user computing device, and/or in some embodiments an optional external control system. For purposes of simplifying the description, process 800 is described as performed by and from the perspective of the apparatus 200.

The process 800 begins at operation 820. At operation 820, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that determines one or more independent semantic object model clusters based on the plurality of independent semantic object models. Each independent semantic object model cluster comprises a subset of the plurality of independent semantic object models having one or more object types shared among the independent semantic object models in the independent semantic object model cluster. A shared object type may describe an instance of an object type that a subset of independent semantic object models have in common.

At operation 840, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that generates one or more similarity scores for each independent semantic object model cluster. Each similarity score for an independent semantic object model cluster may correspond to an object type shared by each independent semantic object model in the independent semantic object model cluster (e.g., common object type among the independent semantic object models in the independent semantic object model cluster). In some embodiments, the apparatus 200 generates the one or more similarity scores for each independent semantic object model cluster based at least in part on the one or more attributes (e.g., object properties, relation links, and/or the like) for each independent semantic object model in the independent semantic object model cluster. In an example embodiment, the apparatus 200 generates the similarity score for each independent semantic object model cluster based at least in part on the respective set of object properties associated with each independent semantic object model in the independent semantic object model cluster. In some embodiments, the similarity score is determined using one or more of a variety of techniques. For example, in one or more embodiments, the similarity score may comprise a cosine similarity-based score. As another example, in some embodiments, the similarity score may comprise Euclidean distance-based similarity score.

At operation 860, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that determines whether a similarity score associated with an independent semantic object model cluster satisfies a similarity score threshold. In some embodiments determining whether a similarity score satisfies the similarity score threshold comprises comparing the similarity score to the similarity score threshold. In some embodiments, a similarity score associated with an independent semantic object model cluster satisfies a similarity score threshold if the similarity score exceeds the similarity score threshold. In some embodiments, a similarity score associated with an independent semantic object model cluster satisfies a similarity score threshold if the similarity score is at least equal to the similarity score threshold.

At operation 880, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that in response to determining that an independent semantic object model cluster satisfies the similarity score threshold, adopts the corresponding object type associated with the similarity score that satisfies the similarity score threshold as a similar object type. As described above, a similar object type may comprise an object type shared among a plurality of independent semantic object models, where the attributes of the object type for each independent semantic object model is substantially similar.

Returning to FIG. 7 at operation 760, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that determines that the at least one similar object type shared between at least the subset of the plurality of independent semantic object models satisfies model updating criteria. In one or more embodiments, determining whether the at least one similar object type satisfies the model updating criteria is determined using a machine learning model. In one or more embodiments, determining whether the at least one similar object type satisfies the model updating criteria is determined using a rules-based engine. It would be appreciated that in other embodiments, other techniques may be employed to determine whether the at least one similar object type shared between at least a subset of the plurality of independent semantic object models satisfies model updating criteria. In some embodiments, the model updating criteria includes a certain percentage (e.g., pre-defined percentage) of the plurality of independent semantic object models 108A-108N having a similar object type with respect to a particular object type (e.g., pump, HVAC, building, etc.). For example, in some embodiments, the model criteria includes a certain percentage (e.g., pre-defined percentage) of unique user identifiers associated with the plurality of independent semantic object models, and that have a particular object type determined to be similar (e.g., at operation 880). Additionally or alternatively, in some embodiments, the model updating criteria includes a minimum number of independent semantic object models having a shared similar object type (e.g., minimum of 20 independent semantic object model 108A-108Ns, minimum of 250 independent semantic object models 108A-108N, and/or the like). Additionally or alternatively, in some embodiments, the model updating criteria includes a minimum number of user identifiers associated with the subset of independent semantic object models 108A-108N having a similar object type. Additionally or alternatively, in some embodiments, the model updating criteria includes a minimum number of independent semantic object models (e.g., the plurality of independent seeded semantic object models) processed. In some embodiments, a similar object type determined to satisfy a model updating criteria may comprise a qualifying similar object type.

At operation 780, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that in response to determining that the at least one similar object type shared between at least the subset of the plurality of independent semantic object models satisfies the model updating criteria, updating the seeded semantic object model based at least in part on the at least one similar object type shared between at least a subset of the plurality of independent semantic object models (e.g., qualifying similar object type). In some embodiments, the seeded semantic object model is automatically updated in response to a determining that the at least one similar object type shared between at least the subset of the plurality of independent semantic object models satisfies the model updating criteria. For example, in some embodiments, updates/changes may be automatically pushed to Seeded semantic object model. In some embodiments, the updating the seeded semantic object model may comprise a semi-automated process. For example, in some embodiments, in response to determining that the at least one similar object type shared between at least the subset of the plurality of independent semantic object models satisfies the model updating criteria, the updates are reviewed and approved before updating the seeded semantic object model.

In some embodiments, updating a seeded semantic object model 106 comprises at least one of generating, within a seeded semantic object model 106, an additional object type corresponding to a qualifying similar object type. Additionally or alternatively, updating a seeded semantic object model comprises modifying, within a seeded semantic object model 106, an existing object type. For example, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that generates, within the seeded semantic object model 106, an additional object type corresponding to a qualifying similar object type in response to determining a qualifying object type that reflects an object type not present in the seeded semantic object model. As another example, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that modifies, within the seeded semantic object model 106, an existing object type in response to a qualifying similar object type that reflects an object type having one or more attributes that is different from existing attribute(s) in the seeded semantic object model. Examples of modifications to an existing object type in a seeded semantic object model may include one or more of adding a new property, changing a property, adding a relation link, changing a relation link, and/or the like associated with the existing object type. As yet another example, in some embodiments, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that replaces, within the seeded semantic object model 106, an existing object type with an object type corresponding to a qualifying similar object type in response to determining a qualifying object type.

At operation 790, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that optionally deploys the updated seeded semantic object model to at least one new independent semantic object model. In one or more embodiments, deploying the updated seeded semantic object model may comprise rendering the updated seeded semantic object model to one or more client devices.

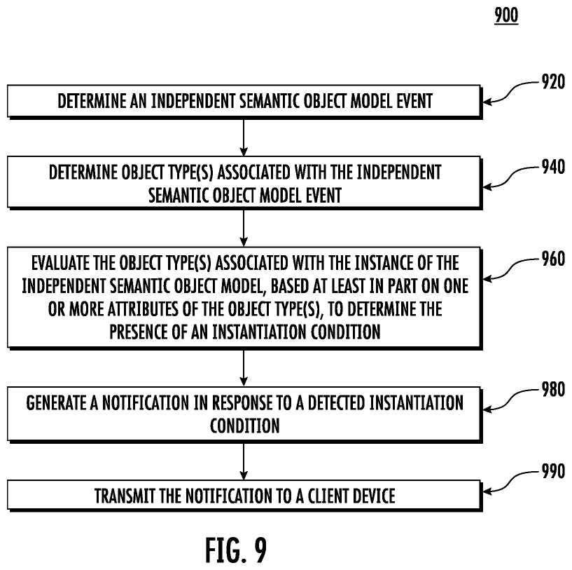

FIG. 9 illustrates a flowchart depicting operations of an example process for evaluating an independent semantic object model 108A-108N in accordance with at least some example embodiments of the present disclosure. Specifically, FIG. 9 depicts operations of an example process 900. In some embodiments, the process 900 is embodied by a computer program code stored on a non-transitory computer-readable storage medium of a computer program product configured for execution to perform the process as depicted and described. Alternatively or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, at least one sensor associated with the at least one apparatus, at least one end-user computing device, and/or in some embodiments an optional external control system. For purposes of simplifying the description, process 900 is described as performed by and from the perspective of the apparatus 200.

The process 900 begins at operation 920. At operation 920, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that determines an independent semantic object model event. In some embodiments, an independent semantic object model event may include an instance of an independent semantic object model 108A-108N. In some embodiments, an instance of an independent semantic object model may include extending a seeded semantic object model (e.g., adding one or more properties, adding a relation link, etc.). Additionally or alternatively, in some embodiments, an instance of an independent semantic object model may include a user-defined object type that is not present in associated seeded semantic object model. It would be appreciated that in some embodiments, an instance of an independent semantic object model may include other actions.

At operation 940, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that determines object type(s) associated with the independent semantic object model event. In one or more embodiments, such object types may include, and without limitation, object type(s) associated with extensions added to a seeded semantic object model and/or user-defined object type(s) not present in the seeded semantic object model.

At operation 960, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that evaluates the object type(s) associated with the instance of the independent semantic object model. In some embodiments, the apparatus 200 may evaluate the object type(s) in real-time or near real-time. In some embodiments, evaluating an object type associated with an instance of the independent semantic object model comprises evaluating one or more attributes (e.g., object properties, relation links, class, space, and/or the like) of the object type to determine the presence of an instantiation condition indicative of error(s) and/or potential issue(s) with respect to object type. For example and without limitation, an instantiation condition may include missing property (e.g., absence of a particular property in a user-defined object type), incorrect property in a user-defined object type, missing relation links, and/or the like.

At operation 980, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that generates a notification in response to a detected instantiation condition. In some embodiments, the notification may include one or more of an alert notification, a warning notification, a recommendation/suggestion notification, and/or the like. In one or more embodiments, the notification describes an error, issue, and/or the like and provides recommendations/suggestions for correcting the error and/or issue.

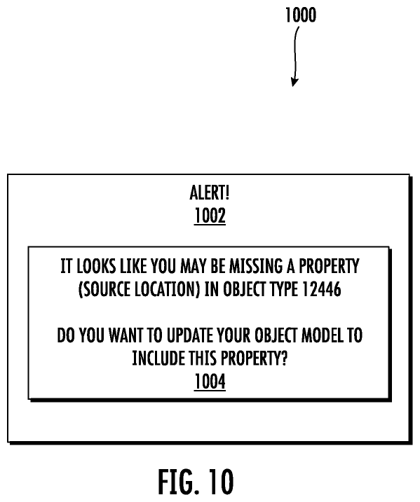

At operation 990, the apparatus 200 includes means such as the data intake circuitry 210, the maintenance circuitry 212, the evaluation circuitry 214, the communications circuitry 208, the input/output circuitry 206, the processor 202, and or the like, or a combination thereof, that transmits the notification generated at operation 980 to a client device. In one or more embodiments, transmitting the notification to a client device may comprise outputting the notification via a notification user interface that is rendered on the client device. FIG. 10 provides an operational example of a notification user interface 1000. The notification user interface 1000 may display various data indicative of one or more of an alert, a warning, a recommendation/suggestion, and/or the like. As shown in the depicted example of FIG. 10, the notification user interface 1000 includes an alert notification 1002 and corresponding details 1004 that describes a missing property in the object type 12446.

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid infrastructures.

A computer-program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for maintaining a seeded semantic object model comprising:
identifying a plurality of independent semantic object models having a plurality of object types, each object type defined by one or more attributes;
processing the plurality of object types to determine at least one similar object type based at least in part on the one or more attributes for each of the plurality of object types, the at least one similar object type shared between at least a subset of the plurality of independent semantic object models;
determining that the at least one similar object type shared between at least the subset of the plurality of independent semantic object models satisfies model updating criteria; and
in response to determining that the at least one similar object type shared between at least the subset of the plurality of independent semantic object models satisfies the model updating criteria, updating the seeded semantic object model based at least in part on the at least one similar object type shared between at least the subset of the plurality of independent semantic object models.

2. The computer-implemented method of claim 1, wherein each of the plurality of independent semantic object models is independently customizable by at least one user.

3. The computer-implemented method of claim 1, wherein the one or more attributes for each object type of the plurality of object types comprises a set of object properties for the object type.

4. The computer-implemented method of claim 1, wherein the at least one similar object type is determined using a machine learning model.

5. The computer-implemented method of claim 1, wherein the at least one similar object type is determined using a rules-based engine.

6. The computer-implemented method of claim 1, wherein the model updating criteria comprise a certain percentage of the plurality of independent semantic object models having the at least one similar object type.

7. The computer-implemented method of claim 1, wherein determining whether the at least one similar object type satisfies the model updating criteria is determined using a machine learning model.

8. The computer-implemented method of claim 1, wherein determining whether the at least one similar object type satisfies the model updating criteria is determined using a rules-based engine.

9. The computer-implemented method of claim 1, wherein updating the seeded semantic object model comprises generating, in the seeded semantic object model, an additional object type corresponding to the at least one similar object type.

10. The computer-implemented method of claim 1, wherein updating the seeded semantic object model comprises replacing an existing object type in the seeded semantic object model with an object type corresponding to the at least one similar object type.

11. The computer-implemented method of claim 1, wherein updating the seeded semantic object model comprises updating, in the seeded semantic object model, at least one object attribute of an existing object type corresponding to the at least one similar object type.

12. The computer-implemented method of claim 1, further comprising deploying the updated seeded semantic object model to at least one new independent semantic object model.

13. The computer-implemented method of claim 1, wherein determining whether to update the seeded semantic object model is performed at a defined time interval.

14. The computer-implemented method of claim 1 further comprising:
evaluating one or more attributes of an object type associated with an instance of an independent semantic object model of the plurality of independent semantic object models for presence of an instantiation condition indicative of a potential issue with respect to the object type;
generating a notification in response to a detected instantiation condition, the notification comprising one or more of an alert notification, a warning notification, a recommendation notification, or a corrective action notification, and/or the like; and
transmitting the notification to a client device.

15. An apparatus for maintaining a seeded semantic object model, the apparatus comprising at least one processor and at least one non-transitory memory including computer-coded instructions thereon, the computer-code instructions configured to, with the at least one processor, cause the apparatus to:
identify a plurality of independent semantic object models having a plurality of object types, each object type defined by one or more attributes;
process the plurality of object types to determine at least one similar object type based at least in part on the one or more attributes for each of the plurality of object types, the at least one similar object type shared between at least a subset of the plurality of independent semantic object models;
determine that the at least one similar object type shared between at least the subset of the plurality of independent semantic object models satisfies model updating criteria; and
in response to determining that the at least one similar object type shared between at least the subset of the plurality of independent semantic object models satisfies the model updating criteria, update the seeded semantic object model based at least in part on the at least one similar object type shared between at least the subset of the plurality of independent semantic object models.

16. The apparatus of claim 15, wherein each of the plurality of independent semantic object models is independently customizable by at least one user.

17. The apparatus of claim 15, wherein the one or more attributes for each object type of the plurality of object types comprises a set of object properties for the object type.

18. The apparatus of claim 15, wherein the at least one similar object type is determined using a machine learning model.

19. The apparatus of claim 15, wherein the at least one similar object type is determined using a rules-based engine.

20. A computer program product for maintaining a seeded semantic object model, the computer program product comprising at least one non-transitory computer-readable storage medium having computer program code stored thereon that, in execution with at least one processor, is configured for:
identifying a plurality of independent semantic object models having a plurality of object types, each object type defined by one or more attributes;
processing the plurality of object types to determine at least one similar object type based at least in part on the one or more attributes for each of the plurality of object types, the at least one similar object type shared between at least a subset of the plurality of independent semantic object models;
determining that the at least one similar object type shared between at least the subset of the plurality of independent semantic object models satisfies model updating criteria; and
in response to determining that the at least one similar object type shared between at least the subset of the plurality of independent semantic object models satisfies the model updating criteria, updating the seeded semantic object model based at least in part on the at least one similar object type shared between at least the subset of the plurality of independent semantic object models.
